(19) United States
(12) Patent Application Publication
(10) Pub. No.: US 2016/0220024 A1
(43) Pub. Date: Aug. 4, 2016

(54) Blinders for Wall Mounted Televsion

(71) Applicant: Brian K. Santerre, Greenwood, IN (US)

(72) Inventor: Brian K. Santerre, Greenwood, IN (US)

(21) Appl. No.: 15/002,728

(22) Filed: Jan. 21, 2016

Related U.S. Application Data
(60) Provisional application No. 62/109,219, filed on Jan. 29, 2015.

(51) Int. Cl. A47B 97/00; F16B 5/00; F16B 2/20; B26D 3/00

(52) U.S. Cl. CPC A47B 97/001; B26D 3/006; F16B 5/0004; F16B 2/20

(57) ABSTRACT

A device, kit, and method for preparing customized blinders to cover spaces between a wall-mounted television and a wall to which it is mounted are provided. Blinders conceal wiring and mounting brackets and are held in place solely by frictional forces to provide an easy-to-install, aesthetic enhancement to any wall-mounted set up.

### CROSS REFERENCE TO RELATED APPLICATIONS

This application claims priority to U.S. Provisional Application No. 62/109,219 filed Jan. 29, 2015 the entire contents of which is herein incorporated by reference.

### FIELD OF THE INVENTION

The present invention relates to wall mounted televisions and more particularly to a device, kit and method for covering the space between the TV and wall to which it is mounted thereby concealing supporting brackets and wiring to provide a safer and more aesthetically pleasing room display.

### BACKGROUND OF THE INVENTION

Trends in television design have moved away from large, bulky cathode ray sets that were placed on tables or inside cabinet, to sets that are mounted to a wall. Wall-mounted TVs (CRT, plasma screen, LED, LCD), or “flat panels” are mounted to a wall by attaching a bracket assembly to the set and affixing the bracket to a wall. Flat panel screens range in size from about 37″-70″ or more.

While flat panel TVs have advanced home entertainment technology, there are some notable drawbacks. Generally, it is desirable that a wall-mounted TV contribute to, rather than distract from, the visual aesthetics of the room. However, when a flat panel TV is mounted to a wall, a space is created between the back of the set and the wall thereby exposing dangling wires and supporting brackets. Aesthetically this can be a needless distraction to people in the room. In addition, many wall-mounted TVs have metal or plastic borders that may conflict or distract from the overall decor of the room which is further enhanced by the trend toward larger TV screens.

In addition to aesthetic concerns, wall mounting provides open access to wiring and mounting brackets which can raise safety concerns especially when small children are present.

A number of solutions to these problems have been developed. For example, it is known to construct a frame or box device around the television screen, and when decorated such devices can complement rather than distract from the room décor. However, devices of this type can be very costly to fabricate and install since customization is required to accommodate uniquely sized monitors and mounts (e.g. straight or tilt). For these reasons standardization is generally not possible. In addition, skilled labor is required to fabricate such custom frames and to ensure proper installation. Moreover, some flat panels cannot accommodate such frames without compromising the structure of the set.

Another approach that has been tried involves placing an ornamental cover over the television screen when the set is not in use. However, covers of this type involve complex and expensive mechanical systems that place the cover over the TV when it is not in use and remove it for viewing. In addition, covering devices of this sort can be unsightly per se and in the end self-defeating for improving aesthetic harmony in a room.

There remains a need for an inexpensive, easy-to-install device, kit, and method for covering the space between a wall-mounted television and the wall to which it is mounted that simplifies customization or adaptation to any wall-mounted television configuration without needing skilled labor to install.

The present invention relates to a device, kit, and method that improves the appearance of wall mounted TVs by covering the space between the TV and wall, thereby concealing supporting brackets and wiring. The invention further relates to a low-cost device and kit that includes easily customizable pieces that a user can adapt to any installation need.

### SUMMARY OF THE INVENTION

The present invention provides an inexpensive, easy-to-use kit, device, and method that includes customizable pieces of material that can be cut to the correct dimensions by a user to fit into the spaces of any wall mounted TV configuration. Custom-sized blinders of the invention can be placed at the sides and bottom (if desired), to beautify the installation by concealing wiring and mounting brackets, as well as to block access to the rear of the monitor. The invention also includes a grill for placement over the top space between the top of the set and wall that does not interfere with proper ventilation and cooling of the TV. When installed, the blinders of the invention create a more appealing presentation by covering wires and mounting brackets that are visible in the space between the TV and wall. The customizable blinders are held in place solely by frictional forces without the need for bolts, brackets, or other mounting means, to secure the pieces in place, thereby avoiding damage to the wall and TV. The invention can be applied to any installation without the need to remove the mount or the TV. In addition, once customized the blinders and/or top grill can easily be removed to access the TV, wires, and mounting brackets for servicing when needed.

In one aspect, the present invention relates to customized wall-mounted TV blinders and a kit that provides a user with a slab of suitable material for customizing a blinder therefrom that can be fit into the spaces of any wall-mounted TV configuration.

In another aspect, the present invention relates to a device, kit, and method adaptable to home or business use for easily and cost-effectively covering the between a wall-mounted TV and wall, thereby concealing wiring and mounting brackets, improving safety, and enhancing aesthetic appeal.

It is an object of the present invention to provide an easy-to-use, cost-effective self-help device, method, and kit for producing a customized TV blinder for business and home use to beautify a wall-mounted TV installation without the need for expensive fabrication and skilled labor to install.

These and other objects and advantages of the present invention will be apparent from the following description, the accompanying drawings, and the appended claims. This Summary is provided merely to introduce certain concepts and not to identify any key or essential features of the claimed subject matter.

### BRIEF DESCRIPTION OF THE DRAWINGS

The drawings provided herein form a part of the specification and are to be construed in conjunction therewith. Like reference numbers have been employed throughout wherever possible to indicate like or similar parts in the various views and embodiments.

FIG. 1A shows a top view of a typical flat panel TV.

FIG. 1B shows a lop view of a flat panel TV mounted to a wall.

FIG. 1C shows a side view of a flat panel TV that is straight-mounted to a wall.

FIG. 1D shows a side view of a flat panel TV that is tilt-mounted to a wall.

FIG. 2A provides a from perspective view of a rectangular-shaped customizable block according to the intention.

FIG. 2B provides a front perspective view of the block of FIG. 2A showing hypothetical dimension lines for customizing blinders to fit a tilt-mounted installation space.

FIG. 2C provides a front perspective view of two tilt-mount blinders cut from the block of FIG. 2B along the displayed dimension lines.

FIG. 2D provides a from perspective view of the block of FIG. 2A showing hypothetical dimension lines for cutting a pair of blinders for a straight-mounted installation space.

FIG. 2E provides a front perspective view of two straight-mount blinders cut from the block of FIG. 2D along the displayed dimension lines.

FIG. 3A provides a side view of a straight-mounted TV showing a blinder of the invention for placement in a side space.

FIG. 3B shows a aide view of the configuration in FIG. 3A after placement of the blinder in the side space.

FIG. 3C provides a side view of tilt-mounted TV showing a customized blinder of the invention for placement in the side space.

FIG. 3D shows a side view of the installation configuration shown in FIG. 3C after placement of the blinder in the side space.

FIG. 4A shows a top view of a customizable grill of the invention for placement in the top space between a wall-mounted TV and wall to which it is mounted.

FIG. 4B shows a top view of the grill of FIG. 4A after customization to fit a larger sized top space.

FIG. 4C shows a top view of the grill of FIG. 4A after customization to fit a smaller sized top space.

FIG. 5 shows a top view of a wall-mounted TV with a grill of the invention installed in the top space.

FIG. 6 shows a front perspective view of a wall-mounted TV after installation of a grill and blinders of the invention.

### DETAILED DESCRIPTION OF PREFERRED EMBODIMENTS

As used herein, the terms “customizable block”, “block”, or “blank” refer to a size and shape-customizable slab of suitable material which is adaptable to be customized by a user in size and shape to prepare a blinder to fit into a space between a wall-mounted TV and wall and be held there solely by frictional forces.

As used herein, the terms “cover” or “blinder” or “customized blinder” refer to a frictionally-mountable member for placement in a space between a wall-mounted TV and wall to which it is mounted. The size and shape dimensions of a blinder allow it to be wedged in a space between a wall-mounted TV and wall to which it is mounted, thereby closing or blocking the space between the TV and wall. In one aspect, a blinder is customized by a user of a kit of the invention.

As used herein, the term “device” or “device of the invention” refers to one or more of a block, cover, blinder, customized blinder, kit, grill, or top grill of the present invention.

As used herein, the terms “frictional mount” or “frictionally-mountable” or terms related thereto refer to an aspect of the invention whereby the blinders are secured in a space between a TV and wall solely by frictional forces between the edges of a blinder and surfaces on the TV monitor and wall, without brackets, screws, nails, glue, tape, or any other type of mounting means.

As used herein, the term “space” is used to refer to the gap between a wall-mounted TV and a wall to which it is mounted. The space or gap may occur at the sides, top, and bottom of the TV. For clarity, sometimes a space may be designated as “top space”, “bottom space” or “side space” to distinguish the particular location of the space vis-à-vis the TV monitor.

As used herein the term “customize” or terms related thereto refer to configuring the size and shape of a blinder to fit a particular installation. In one aspect the term refers to steps taken by a user of the invention to configure a block of suitable material to produce a customized blinder, or customized grill to be fit into a space at the sides, bottom (if desired) and top of a particular wall-mounted TV installation. The term may also refer to a process by which a user measures distances between the TV and wall at the top and bottom of the back panel of the monitor, and the length across the top of the back panel of the TV monitor, and then cuts away or removes portions of a block to create an appropriately-sized and shaped blinder, and/or grill for a proper fit into a particular wall-mounted TV installation.

The present invention provides a device, frictionally-mountable blinder, top grill, kit, method, and product-by-process for covering the spaces around a wall-mounted TV and wall. The invention provides a self-help, easy-to-use, low cost option for home and business use that avoids the need to hire skilled labor for fabrication and installation. The invention provides frictionally-mountable, customized blinders that are adaptable to fit any wall-mounted TV installation including straight and tilt-mounted configurations. The blinders and top grill of the invention can be installed without the need to dismount the TV from the wall, and once installed, can easily be removed whenever necessary.

The invention also addresses safety concerns. Open spaces between a TV and wall can be accessed by children with the potential for damage to property or bodily harm. A device of the invention provides a cost-effective, easy-to-use means to block access to these spaces thereby reducing the chance of accident.

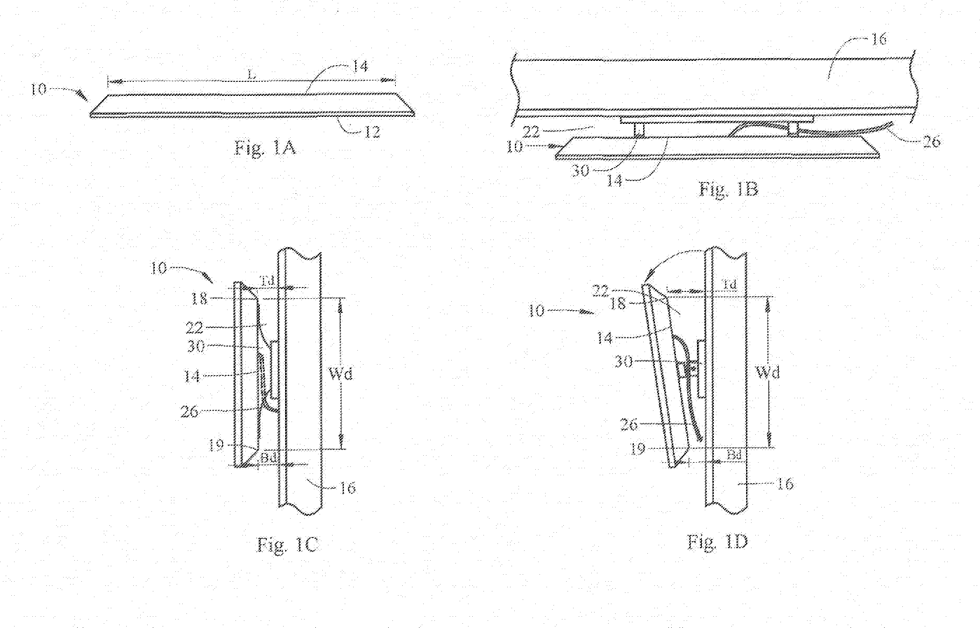

FIGS. 1-6 will now be discussed to illustrate certain preferred embodiments of the invention. Certain features illustrated in the drawings may not be drawn to scale. It should be understood that the invention is not limited to the precise forms of the preferred embodiment(s), apparatus, device, method, or material, as disclosed herein, and that changes may be made without departing from the scope of the invention.

FIG. 1 shows a typical wall-mounted TV installation. FIG. 1A illustrates a flat-panel TV monitor 10 having a front panel 12, or screen, a back panel 14, and a length L across the top of back panel 14. As shown in FIG. 1B, when monitor 10 is mounted to a wall 16, a space 22 is created between the top, sides, and bottom of monitor 10 and wall 16, thereby exposing wiring 26 and mounting brackets 30. A side view of a straight mounted TV (FIG. 1C) shows that an orthogonal protection from the top 18 of back panel 14 to wall 16 defines a distance, Td, and an orthogonal projection from the bottom 19 of back panel 14 to wall 16 defines a distance Bd. The distances Td and Bd are about the same in a straight-mount configuration and define the width of the side space. The length of the side space from top to bottom, Wd, is defined by the distance between the top 18 and bottom 19 of back panel 14. FIG. 1D shows a tilt-mounted configuration in which the top of monitor 10 is tilted away from wall 16, and the distance Td between the top 18 of back panel 14 of monitor 10 and wall 16 is greater than the distance Bd between the bottom 19 of back panel 14 and wall 16. The length of the space from top to bottom in a tilt-mount configuration, Wd, is measured by an orthogonal projection from the top 16 and bottom 19 of back panel 14. Generally, Td and Bd would be from 2 to 12 inches or more depending on the particular mounting bracket 30 that is used (i.e. straight or tilt).

As illustrated in FIGS. 1B-1D, space 22 surrounds the monitor at the sides, top and bottom, and can vary in size, dimension, and configuration, depending on the particular monitor and type of mount. As a result, a “one-size-fits-all” standard for blinders is not practical and customization is required to fit a particular installation. The present invention provides a convenient, low-cost, easy-to-use solution.

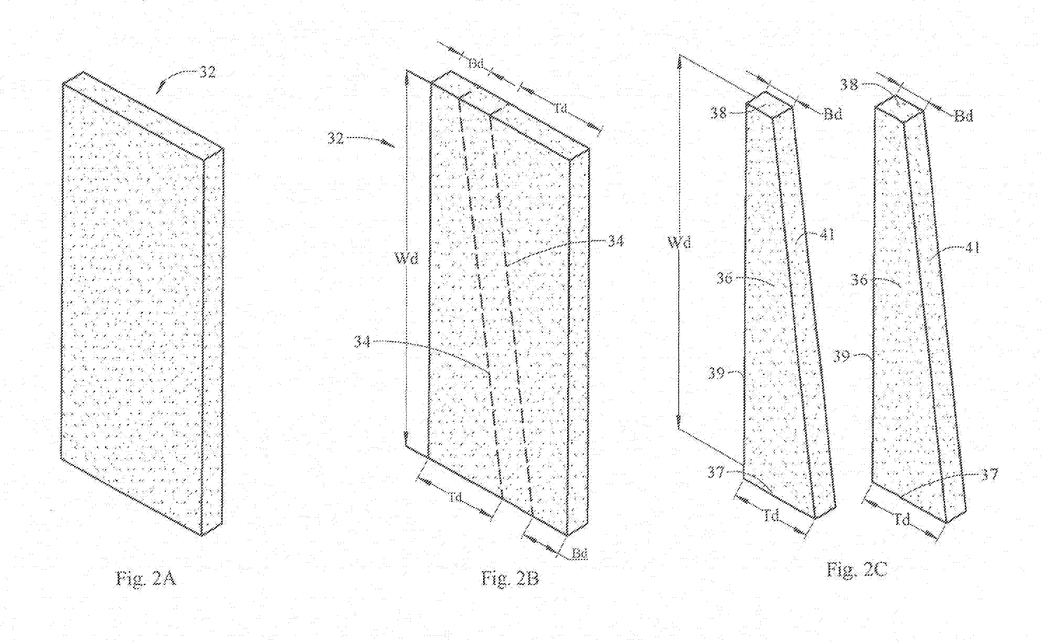

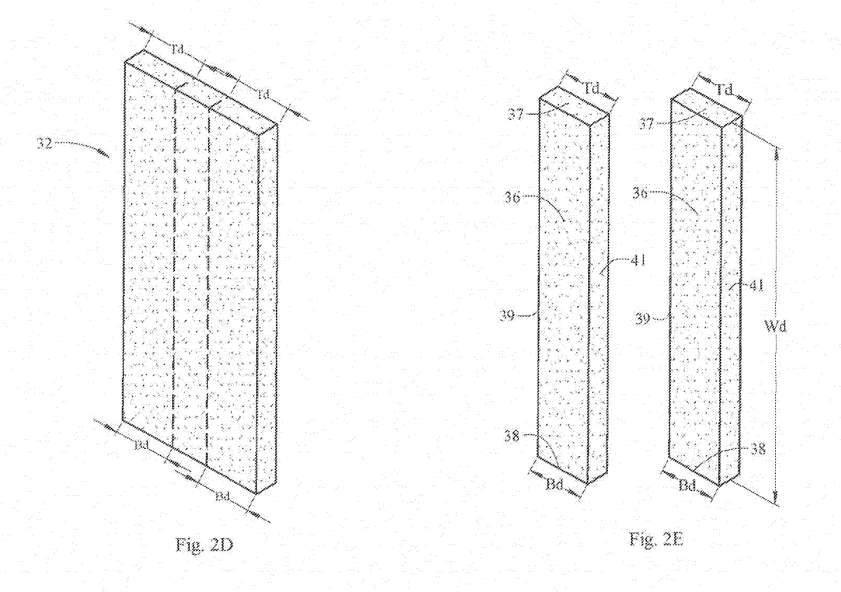

Referring now to FIG. 2, preferred embodiments of a dimensionally customizable block member 32 and customized blinders 36 cut therefrom are described. FIG. 2A shows a front perspective view of a block 32 according to the invention. Blocks may be of any size that is large enough to accommodate cutting one or more blinder(s) therefrom, preferably two blinders. Blocks are preferably rectangular in shape and may be from 15 inches to 50 inches in length, 5 inches to 30 inches in width, and 1 to 2 inches in thickness having top and bottom planar surfaces FIG. 2B shows a block in which hypothetical right-angled trapezoidal dimension lines 34 have been inscribed on the surface of block 32 to cut two blinders for a tilt-mounted side space, with dimension Td representing the distance between the top of a TV monitor and wall, and dimension Bd the distance between the bottom of the monitor and wall. FIG. 2C illustrates two blinders 36 prepared by cutting along dimension lines 34 on block 32 of FIG. 2B, having a top edge 37 of dimension Td to fit in the space at the top of the monitor, a bottom edge 38 of dimension Bd to fit in the space at the bottom of the monitor, a wall-contacting edge 39 for contacting the wall surface when installed, and a TV monitor-contacting edge 41 for contacting the back panel of the TV monitor when installed. Dimension Wd specifies the length of wall-contacting edge 39, which correlates with the length from top to bottom of a side space to be filled. The angle and length of monitor-contacting edge 41 is defined by the length and configuration of the other three edges. Generally, edges 38 and 39 are orthogonal to each other, as are edges 37 and 39.

FIGS. 2D and 2E illustrate customization of a block 32 for a straight-mount installation in which the Td dimension at upper end 37, and the Bd dimension at lower end 38 are approximately equal to reflect a straight-mount configuration. In a straight-mount configuration, the blinders 36 are rectangularly-shaped with orthogonally-oriented edges, and the wall-contacting edge 39 and monitor-contacting edge 41 are equal or about equal in length, as represented by dimension Wd.

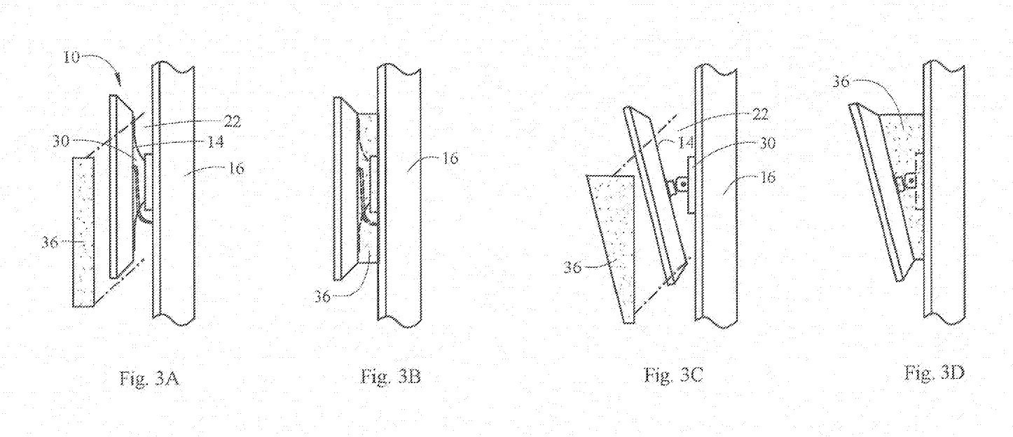

FIGS. 3A to 3D show side views of straight-mounted (FIGS. 3A & 3B) and tilt-mounted (FIGS. 3C & 3D) configurations, and placement of customized blinders 36 of the invention into the side space 22. After installation of the blinders, wiring and mounting brackets are no longer visible from the side of the set (FIGS. 3B and 3D).

In one aspect, the invention relates to frictionally-mountable television blinders for placement in a side space or bottom space of a straight-mounted to tilt-mounted configuration. The blinders are sized and configured to be wedged into a space and secured there solely by frictional forces. Blinders are generally rectangular or right-angled trapezoidal in shape depending on the type of installation. Each blinder has front side and back planar surfaces and four peripheral edges, a top edge, bottom edge, wall-contacting edge, and a TV monitor-contacting edge. For a straight-mount configuration, the blinder is rectangular-shaped with the wall-contacting and monitor-contacting edges parallel to each other and orthogonal to the top and bottom edges. For a tilt-mount installation, the top and bottom edges are parallel to each other and orthogonally-oriented with the wall-contacting edge, while the monitor-contacting edge forms an angle less than 90° with the top edge and more than 90° with the bottom edge.

In another aspect, the present invention relates to a grill member for placement over the top space between the top of the monitor and wall. The top space is generally rectangularly-configured with dimensions that are determined by the particular monitor and type of mount. In a preferred embodiment, the grill is adaptable for easy customization by including a plurality of spaced-apart score lines which facilitate size customization, or in an alternative embodiment by incorporating a plurality of telescoping, slidably-engaging panels that can be compressed or expanded to change the length and/or width of the grill.

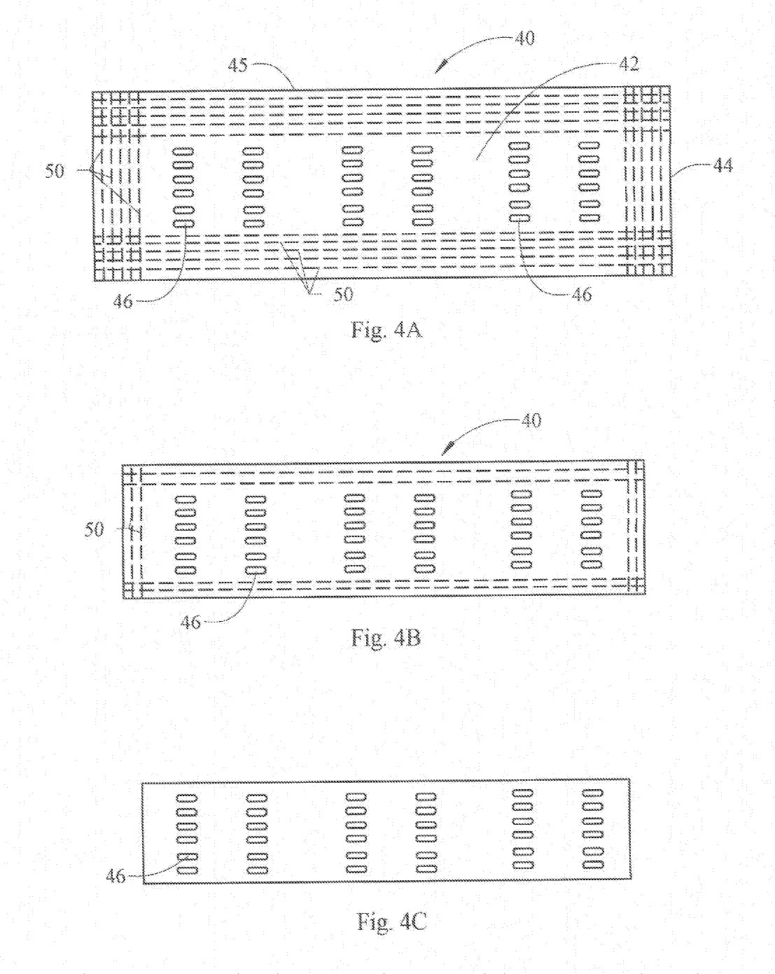

FIG. 4A illustrates a top grill 40 according to one embodiment of the invention. Grill 40 includes a plurality of ventilation holes 46 which facilitate proper ventilation of the monitor during operation. Ventilation holes 46 penetrate through the grill and can be included in any number and any distribution pattern. For example, as illustrated, holes 46 can be aligned in rows along the horizontal and vertical axes of the grill, or they can be arranged diagonally to the axes (FIG. 6). Ventilation holes 46 can be of any size and shape, including, for example, circular, oval, and rectangular, and between ⅛ inch to 2 inches in length or diameter, alternatively from ⅛ inch to 1 inch; alternatively from 1/8 inch to 0.5 inches. Preferably holes 46 are between ⅛-¼ inch if circular, and between 0.5 inch to 2 inch in length, alternatively from 0.5 inch to 1 inch, if rectangular.

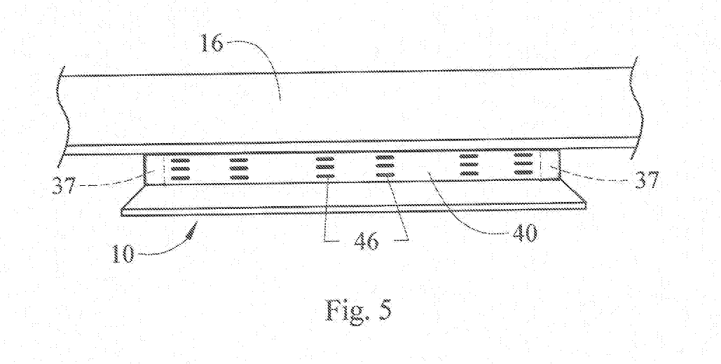

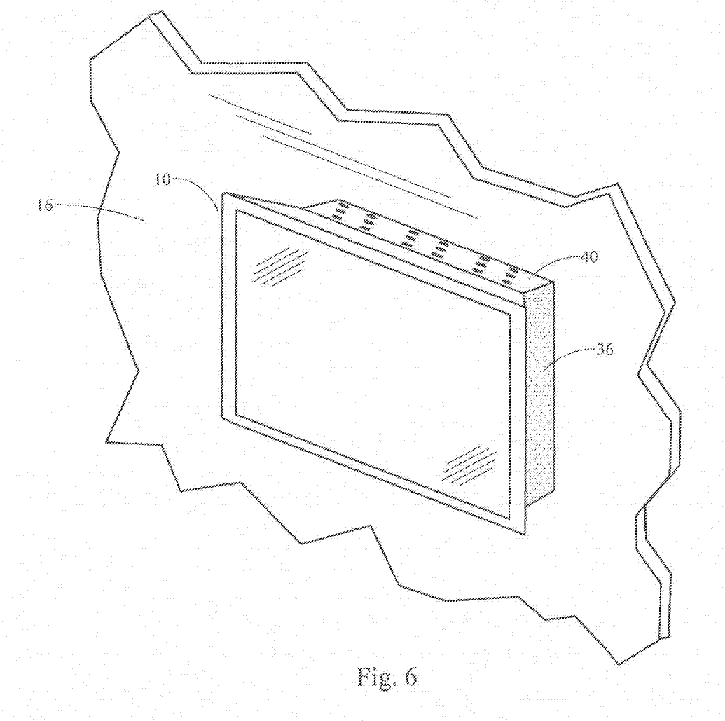

In a preferred embodiment, a plurality of inwardly diminishing score lines 50 or indentations are positioned longitudinally and transversely on one or both surface(s) of grill 40, extending parallel to the four peripheral edges of the grill to provide break-away rectangular segments. Adjacent score lines can be applied in ⅛^{th} to ¼ inch increments, alternatively in ¼ to ½ inch increments or am other desired increment. Score lines are provided as an aid to the user during customization to easily snap or break away segments of the grill to achieve a proper size to fit the top space without the need for cutting tools. For illustration, FIGS. 4B and 4C show the grill in FIG. 4A after breaking away segments along the score lines to fit larger or smaller-sized top spaces, respectively. It will be appreciated that other break patterns could be appropriate depending on the dimensions of the monitor and particular installation. As shown in FIGS. 5 and 6, after a grill has been customized, it is placed on the upper ends 37 of blinders 36 in the top space.

Blocks can be fabricated from any suitable material. Preferably the material is lightweight and flexible to allow frictional mounting of blinders cut therefrom in the space between the TV and wall. It is also preferred that the material be soft for easier cutting during customization of blinders. Blocks and blinders can be made from rubber, plastic, vinyl, foam rubber, or an open-cell or closed-cell foam material such as Styrofoam®, polystyrene, polyurethane, or any other suitable foam. The density of blocks can range from 0.3 to 10 lbs/ft³, alternatively from 0.3 to 5 lbs/ft³, alternatively from 0.3 to 3 lbs/ft³, alternatively from 0.85 to 1 lb/ft³. In a preferred embodiment, blocks are fabricated from soft, flexible polyurethane foam having a density of 0.9 lbs/ft³. The table below provides exemplary specifications for a polyurethane block.

TABLE 1
Exemplary polyurethane foam block physical properties

| Property | Value | Range |
|---|---|---|
| Density (lbs/cu.ft.) | 0.9 | .85-1.0 |
| Indentation Force | @ 25% 30.0 | 27-33 |
| Deflection (IFD; lbs/50 sq. | @65% 46 | 20-50 |
| in.) | | |
| Support Factor | 1.9 | 1.5-3 |
| Dynamic Fatigue IFD loss | 40 | |
| @25% | | |
| Hysteresis (% retained) | 60 | 50-70 |
| Resilience (ball rebound) | 40 | 20-80 |
| Airflow (cfm) | 2 | 2-10 |
| Tensile (psi) | 9 | 9-25 |
| Tear (pli) | 1.3 | 1-10 |
| Elongation (2.5 in. gauge | 120% or original | |
| length) | | |
| Compression Set (@ 90% | 15 | |
| deflection) | | |

For enhanced aesthetic appeal, blocks can be colored throughout or on one or both surfaces to coordinate with the particular TV monitor and/or room where it is installed. Preferably, blocks are colored black, charcoal, or gray to coordinate with the majority of TV sets but other colors are also within the scope of the invention including red, orange, yellow, green, blue, indigo, and violet, as well as shades and mixtures thereof, and any color in the visible spectrum. Blocks can also include any desired decorative pattern or indicia on one or both surfaces such as, for example, a geometric pattern or shape, stripes, swirls, circles, any polygonal shape, balloons, floral pattern, rock pattern, wood pattern, stone pattern, landscapes, logos, etc. Coloring can be added to blocks as a dye during manufacture or it can be applied as a paint or dye after manufacture. Design indicia can be applied to blocks or blinders by any suitable method known to the skilled artisan such as by painting or stenciling.

A grill of the invention is preferably rectangular-shaped with longitudinal and transverse axes having length and width dimensions sufficiently large to fit any top space and installation set-up. A grill can be up to 60 inches in length or greater, alternatively from 20 to 60 inches, alternatively from 20 to 50 inches, alternatively from 20 to 40 inches, alternatively from 20 to 30 inches, a width from 3 to 20 inches, alternatively from 5 to 18 inches, alternatively from 5 to 15 inches, and a thickness of 1/16^{th} to ¼^{th} inch, alternatively from ⅛^{th} to ⅜^{th} inch. The grill can be fabricated from metal, wood, masonite, plastic, or any other suitable material and be of any desired color. Score lines can be applied to one or both surfaces during or after fabrication using a scoring knife or other sharp object. If applied to both surfaces, score lines are placed at equivalent distances from the edges to facilitate breaking. The score lines render the grill adaptable to easily break when a user pulls or pushes along the line, or gently taps with a hammer to cause a break at the desired score line.

In another aspect, the invention relates to a kit which includes one or more block members of the invention from which blinders can be customized to fit spaces between a wall-mounted TV and wall. A kit may also include a customizable top grill for placement in a top space. A kit preferably includes instructions, on or inside the packaging of the kit, directing the user how to customize the size, shape, and overall dimensions of block members and/or a grill to fit the particular installation space. Kit instructions preferably also include one or more drawings to assist the user in understanding the installation instructions. A kit may optionally also include one or more cutting tools, for example, knife, saw, file, sandpaper. NiChrome wire, and a measuring device such as a ruler or tape measure.

In one embodiment a kit of the invention is provided with blocks that are adaptable for use with monitors of all sizes. In another embodiment, kits are provided for specifically-sized TVs. For example, a kit for a small set would accommodate a screen size between 13 inches and 37 inches. A kit for a medium-sized TV would accommodate a screen size between 37 inches and 55 inches. A kit for a large-sized TV would accommodate a screen between 55 inches and 80 inches. A kit for an extra large sized TV would accommodate a screen between 70 inches and 96 inches. Depending on the size and configuration of the mounting, an appropriately-sized kit would be selected. Each kit would include one or more blocks, preferably rectangular-shaped rubber or foam for customization by a user to fit into a space. Block(s) in a small kit would have dimensions before customization of 20 inches (length)×8 inches (width)×1 inch (thickness), block(s) in a medium kit would have dimensions before customization of 30 inches (length)×12 inches (width)×1 inch (thickness); block(s) in a large kit would have dimensions before customization of 42 inches (length)×20 inches (width)×1.5 inches (thickness), block(s) in an extra-large kit would have dimensions before customization of 50 inches (length)×24 inches (width)×15 inches (thickness).

In using a kit of the invention a user first determines the dimensions of the space(s) to be covered. A side space for a straight-mounted installation would generally be rectangular, with a top distance Td between the top of the back panel of the monitor and wall, and a bottom distance Bd between the bottom of the back panel of the monitor and wall, generally being equal and representing the width of the space to be covered, and the width of a blinder to fit in the space (FIG. 1C). The length dimension of the space (and blinders) is determined as the distance between the top and bottom of the back panel of the TV monitor or an orthogonal projection therefrom to the wall. The same process is carried out for a tilt-mounted installation, except that in this case the side space would generally be right-angled trapezoidal in shape rather than rectangular, with the top dimension Td being larger than the bottom dimension Bd. Regardless of the type of mount, customization results in blinders that can be wedged into the space and secured there solely by frictional forces.

To install a grill in the top space, a user determines the proper length for the grill by measuring the distance (L, FIG. 1A) across the top of the back panel of the monitor, and determines the appropriate width by measuring the distance between the top of the monitor and the wall (Td, FIGS. 1C and 1D). In one embodiment, the user transfers the measured dimensions to the top grill using any suitable marking tool and cuts the grill to the proper dimension by any suitable means known to the skilled artisan. In the preferred embodiment, the process is simplified by having a plurality of score lines on the grill which allow a user to customize the grill without the need for a knife or other cutting tool.

After customizing the blinders and top grill, they are ready to be installed. Blinders are wedged into the side spaces where they are secured in place solely by frictional forces. The grill is laid over the top space and rests on the top ends of the blinders at both sides. Since the blinders and grill are not permanently fixed to the monitor or wall, they can easily be removed whenever desired, for example, to perform maintenance or repair work.

While certain preferred embodiments of the device, kit and method of the present invention have been described, it should be understood that the invention is not limited to the precise form of device or material, and that changes may be made therein without departing from the scope of the invention.

What is claimed is:

1. A customized television blinder for frictional mounting in a side space between a back panel of a wall-mounted television monitor and a wall, produced by the process of:
a providing a block of lightweight material having front and back planar surfaces, a length of 15 to 50 inches, a width of 5 to 30 inches, and a thickness of 1 to 2 inches, adaptable for customizing a blinder having top, bottom, TV monitor-contacting, and wall-contacting edges.
b. projecting an orthogonal line from the top of the back panel of the monitor to the wall to define
i. a width for the top edge, and
ii. a first end for the wall-con lading edge;
c. projecting an orthogonal line from the bottom of the back panel to the wall to define
i. a width for the bottom edge; and
ii. a second end for the wall-contacting edge,
d. measuring the distance between the first and second ends to define a length for the wall-contacting edge of the blinder;
e. transferring the dimensions measured in steps b-d to the block such that one end of the top edge projects orthogonally from the first end of the wall-contacting edge and one end of the bottom edge projects orthogonally from the second end of the wall-contacting edge, wherein the TV monitor-contacting edge is defined by connecting the free ends of the top and bottom edges; and
f. cutting the block according to the dimensions transferred at step e to produce the customized blinder.

2. The blinder of claim 1 wherein the block is fabricated from rubber, plastic, or foam.

3. The blinder of claim 2 wherein the block is foam selected from Styrofoam®, polystyrene, and polyurethane.

4. The blinder of claim 3 wherein the block is polyurethane having a density of 0.3 to 3 lbs/cu. ft. and an IFD at 25% of 27 to 33 lbs/50 sq. in.

5. The blinder of claim 4 wherein the block has a density of 0.85 to 1 lb/cu ft.

6. A method for covering a space between a wall-mounted television monitor and a wall comprising the steps of:
a. providing a block of foam or rubber material having front and back planar surfaces, a length of 15 to 50 inches, a width of 5 to 30 inches, and a thickness of 1 to 2 inches, adaptable for customizing a blinder having top, bottom, TV monitor-contacting, and wall-contacting edges;
b. projecting an orthogonal line from the top of the back panel of the monitor to the wall to define
i. a width for the top edge; and
ii. a first end for the wall-contacting edge;
c. projecting an orthogonal line from the bottom of the back panel to the wall to define
i. a width for the bottom edge; and
ii. a second end for the wall-contacting edge;
d. measuring the distance between the first and second ends to define a length for the wall-contacting edge of the blinder;
e. transferring the dimensions measured in steps b-d to the block such that one end of the top edge projects orthogonally from the first end of the wall-contacting edge and one end of the bottom edge projects orthogonally from the second end of the wall-contacting edge, and wherein the TV monitor-contacting edge is defined by connecting the free ends of the top and bottom edges;
f. cutting the block according to the dimensions transferred at step e to prepare a customized blinder, and
g. wedging the customized blinder in the space to be held solely by frictional forces.

7. A kit for preparing a frictionally-mountable television blinder for placement in a space between a wall-mounted television and a wall to which it is mounted, comprising:
a rectangular block of lightweight material having a density of 0.3 to 10 lbs/cu. ft, a length of 15 to 50 inches, a width of 5 to 30 inches, and a thickness of 1 to 2 inches, wherein the block is adaptable to be customized by a user to fit into the space and be held there solely by frictional forces.

8. The kit of claim 7 wherein the block has a length of 20 inches a width of 8 inches, and a thickness of 1 inch.

9. The kit of claim 7 wherein the block has a length of 30 inches, a width of 12 inches, and a thickness of 1 inch.

10. The kit of claim 7 wherein the block has a length of 42 inches, a width of 20 inches, and a thickness of 1.5 inches.

11. The kit of claim 7 wherein the block has a length of 50 inches, a width of 24 inches, and a thickness of 1.5 inches.

12. The kit of claim 7 further comprising a top grill fabricated from wood, plastic, masonite, or metal.

13. The kit of claim 12 wherein the grill has a plurality of inwardly diminishing longitudinal and transverse score lines on at least one surface allowing a user to break off portions of the grill to customize the fit without the need for cutting tools.

14. The kit of claim 7 wherein the block is fabricated from rubber, foam-rubber, Styrofoam®, polystyrene, or polyurethane.

15. The kit of claim 14 wherein the block is fabricated from polyurethane.

16. The kit of claim 15 wherein the block has a density of 0.85 to 1 lbs/cu. ft. and an IFD at 25% of 27 to 33 lbs/50 sq. in.

17. The kit of claim 16 wherein the block is colored black, charcoal, gray, red, orange, yellow, green, blue, indigo, violet or a mixture thereof.

18. The kit of claim 17 wherein at least one surface of the block provides decorative indicia selected from geometric shape, stripes, swirls, circles, rock pattern, wood pattern, landscape and logo.
